(19) United States
(12) Patent Application Publication
(10) Pub. No.: US 2019/0143351 A1
(43) Pub. Date: May 16, 2019

(54) SHOWER AND BATH NOZZLES

(71) Applicant: NuWhirl Systems Corporation, Corona, CA (US)

(72) Inventor: Richard Rivera, Corona, CA (US)

(21) Appl. No.: 16/181,699

(22) Filed: Nov. 6, 2018

Related U.S. Application Data
(60) Provisional application No. 62/585,496, filed on Nov. 13, 2017.

(51) Int. Cl. B05B 7/04; B05B 1/18; B01F 3/04

(52) U.S. Cl. CPC B05B 7/0425; B01F 2003/04858; B01F 3/04099; B05B 1/185

(57) ABSTRACT

This disclosure relates to nozzles, in particular bath and shower wands that may be hand held and which generate microbubbles from water saturated with air. The bath and shower wands comprise an elongate body comprising an inlet, an elongate outlet and internal flow constriction that can generate micro bubbles from water passing through the wand.

INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

This disclosure relates to shower and bath nozzles, systems containing them and methods of using them. In particular, this disclosure relates to hand-held devices, such as bathing wands, that can produce bubbles from a liquid saturated with gas. The devices can produce micro bubbles, which are desirable in bathing.

### Background of the Invention

Various shower and bathing devices, such as shower heads, hand-held devices and the like are well known for controlling the direction or characteristics of fluid flow as it exits an enclosed chamber or pipe for bathing.

Some such devices are designed to cause liquid flowing through them (such as water) that is saturated with gas (such as air), to release gas in the form of micro bubbles. Micro bubbles are becoming popular in bathing. In a shower or bath, for example, micro bubbles in the water can produce a pleasing bathing experience. Micro bubbles in the water of a bath can appear like a white cloud, otherwise known as a “milk bath,” which is similarly pleasing and may have some hygienic or health benefits. Directing micro bubbles onto the body while bathing can also have beneficial effects or enhance the bathing experience.

While production of some micro bubbles may have some utility, it is preferred that the generation of micro bubbles be maximized otherwise, for example, bath water may have a relatively fewer micro bubbles and the appearance and/or effects may be correspondingly diminished, when bathing or directing micro bubbles onto the body. Maximizing the production of micro bubbles, however, typically requires rather complex nozzle systems that are therefore relatively expensive.

The use of micro-bubbles in therapy bathing has grown substantially over the past few years. However, because micro bubbles are generally dispersed into the bath water, the benefits provided by micro-bubbles are not generally available to the upper torso or the facial region unless the occupant submerges themselves in the bath water. This can be problematic for walk-in bath consumers, as well as those with limited mobility.

It would be advantageous if a relatively simple device could be designed to compete with more complex and therefore more expensive designs and yet match or substantially match not only the degree of micro bubble production, but also be in a format or construction that is easy to use.

Due to this need, a hand-held shower wand capable of dispersing micro-bubbles without a typical spray pattern or water pressure is needed. The design should be contemporary, but universal, allowing for the widest flexibility when paring with other bathing hardware. Ultimately, the shower wand must produce micro-bubbles substantially equal to those produced in the tub itself.

### SUMMARY OF THE INVENTION

This disclosure provides micro bubble bathing devices, particularly hand-held devices, suitable for generating micro bubbles, comprising a chamber having an inlet port and an elongate outlet port, the inlet port communicating with an inlet or proximal end, and the outlet port being adjacent the distal end. The device is generally elongate and can be in the form of a cylindrical housing. The device can have a region between the inlet or proximal end on the one hand, and between the outlet or distal end on the other hand that provides a hand grip area. This structure can cause a pressure drop in liquid traveling from the inlet end to the outlet port. This disclosure provides such nozzles and nozzle systems comprising them, including those that have only one outlet port. The outlet port can be an elongate slit or slot.

A discharge channel or outflow passage can be located in a generally tubular structure having a central longitudinal axis. The nozzle or wand can have a plurality of discharge outlets, but it is preferred to have a single discharge outlet or outlet port. Preferably the discharge channel or outflow passage comprises an internal passage in fluid communication with the inlet and outlet.

The device of this disclosure may comprise an elongate member having a proximal end and a distal end. The device may have a wall or walls extending between the proximal and distal ends and forming, for example, a generally cylindrical body having a longitudinal, central axis.

Preferably, the body of the device is generally cylindrical and is formed by a wall extending between the distal end and the proximal end.

The outlet is typically located in the wall. The outlet port can be offset with respect to the longitudinal axis, for example by being located in the wall of the device near the distal end of the device.

The hand held section or position can be located between the inlet or proximal end and the outlet and can be formed by such a cylindrical wall. Walls of other shapes, such as square, rectangular, polygonal outer cross section may be used.

The distal end of the body of the device may comprise a transverse wall. The wall may, in use, act to cause water traveling through the device to be deflected back and through the outlet. This may enhance the production of desirably small micro bubbles.

The proximal end may have a fitting for connection to a supply of water saturated with air, which may be in the form of conventional piping or more preferably a flexible tube.

The device may have at least one outlet adjacent the distal end and preferably has a single such outlet. The outlet can be formed in the walls that form the body of the device. The outlet is typically an elongate slot or slit, which may extend generally parallel to the longitudinal axis along the wall of the device or may extend generally perpendicular to that axis, for example at least partially around the circumference or outer periphery of the external wall of the device.

The dimensions of the elongate slot or slit may be chosen so as to ensure that water leaves the device with sufficient velocity so as to be projected therefrom.

The device is provided with at least one internal flow constriction, preferably one such internal constriction. The constriction may be in the form of a relatively small hole or orifice which is preferably located on the longitudinal axis and may be formed in a wall extending between the interior walls of the device. This constriction thereby can close off the interior of the body of the device, except for the hole, and thereby form a first flow chamber between the flow constriction wall and the inlet a second flow chamber downstream between the flow constriction wall and the outlet. The constriction may be adjacent the inlet to the device.

In use, the constriction hole acts to generate micro bubbles in water saturated with air that may be supplied to the device, such as via the proximal end, opening or inlet. The hole can be circular.

The ratio between the cross sectional area of the outlet and the cross sectional area of the restriction passage can be from about 20:1 to about 30:1, for example about 23:1

Preferably, there is no other flow constriction downstream of the internal flow constriction until the outlet.

The device can be about 6 to 12 inches long, but preferably is an intermediate value of that range at about 7 to 9 more preferably about 7 to 8 inches long so as to provide adequate length for the device to be hand-held and accommodate the outlet.

The external diameter or width of the device can be from about ¾ inch to about 2 inches, but preferably is about 1 inch.

The outlet slot that is generally parallel to the longitudinal axis of the device can be about 1 to 3 inches long preferably about 2 to 3 inches long. That slot may be about 16^{th} to 8^{th} of an inch wide. Alternatively, the outlet slot can be generally perpendicular or transverse to the longitudinal axis, for example around a portion of a circumferential or other shaped outer wall. Such a slot may be 1 to 1¾ inches long, preferably about 1 to 1½ inches long.

The ratio of the length to the width of the outlet, in the form of an elongate slot or slit, can be from about 30:1 to about 50:1, especially in the case of an outlet extending generally parallel to the longitudinal axis of its device; or preferably about 40:1.

The constriction hole can be about ⅛ inch to about 3/16 inch in diameter, preferably about 1/16 inch to about ⅛ inch in diameter.

The constriction hold or orifice acts as a venturi in use, because of the decrease in cross-section of the interior of the device through which the water/air mixture flows. The same effect can be achieved with a tube that is substantially smaller than the internal cross-section or bore of the device.

This disclosure provides baths or showers incorporating at least one micro bubble device disclosed herein, such as a walk in bath.

This disclosure provides a method of making micro bubbles which comprises supplying water saturated with air to the micro bubble device disclosed herein.

### BRIEF DESCRIPTION OF THE DRAWINGS

Some preferred features of this disclosure will now be more particularly described by reference in and to the following drawings, which are only exemplary of the disclosure.

FIG. 1 is a schematic representation of a system comprising a micro bubble device according to this disclosure connected to a supply of water saturated with air and a bath.

FIG. 2 is a schematic representation of a micro bubble device according to this disclosure;

FIG. 3 is a schematic, top-end view of the device of FIG. 2;

FIG. 4 is a schematic, bottom end view of a device according to this disclosure.

FIG. 5 is a schematic, representation of an alternative micro bubble device according to this disclosure.

### DETAILED DESCRIPTION OF THE PREFERRED EMBODIMENT

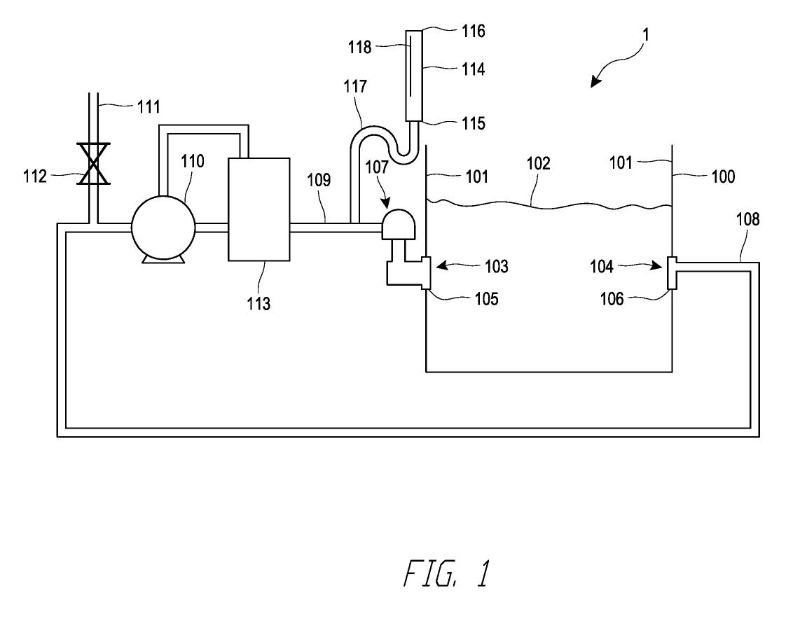

FIG. 1 illustrates a hydrotherapy system 1 comprising a bath 100 having side walls 101 so as to contain water 102 therein. Side walls 101 have holes 103 and 104 in which fittings 105 and 106, respectively, are attached in a conventional manner so as to attach to the outside of the bath an optional nozzle assembly 107 and pipe 108, respectively. Nozzle 107 receives an inlet pipe 109.

Pipe 108 is a return pipe for recycling water from the bath 100 driven by a pump 110. Pump 110 draws water past an inlet 111 to the system that is open to a supply of gas such as air and has a restriction feature 112 to regulate the amount of air drawn into the system.

Pump 110 draws water and air into a mixing tank 113 where, in a manner known in the art, air is caused to be dissolved in or to saturate the water for supply along pipe 109 to the bath 100. Alternatively, air can be supplied directly into mixing chamber 113.

A micro bubble device 114 of the present invention is provided adjacent to or mounted to bath 100 and comprises an inlet end 115 and an outlet end 116.

Inlet end 115 is attached to a conduit 117, preferably a flexible conduit, that is connected to water supply pipe 109.

Adjacent outlet end 116, of micro bubble device 114, is provided an elongate outlet port 115 in the form of a slit or slot.

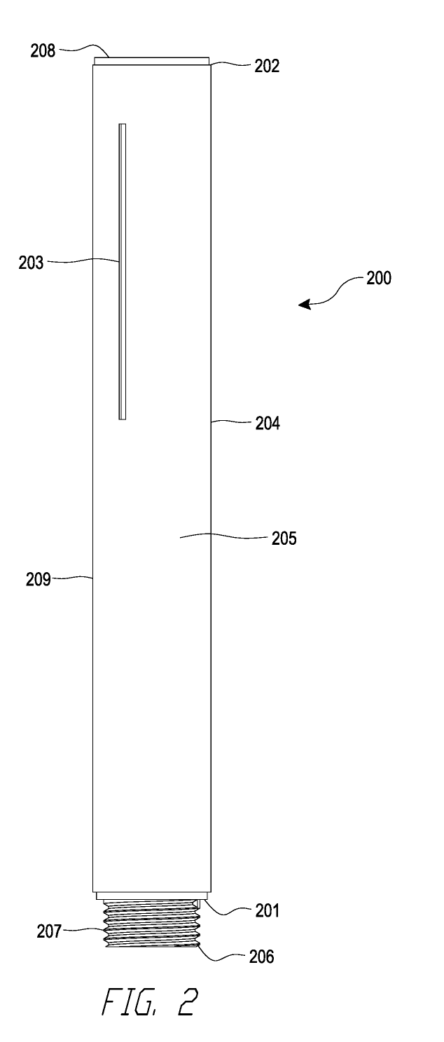

FIG. 2 illustrates a micro bubble device 200 comprising an inlet end 201 and an outlet end 202 and an outlet port 203. Device 200 comprises a body 204 comprising a generally cylindrical wall section 205 and a proximal, connector section 206. Connection section 206 has threading 207, for connection to a water supply pipe or tube (not shown). Outlet end 202 is provided with a cap section 208 to seal the distal end of the cylindrical body 204 for attachment to other system components via a water supply hose (not shown). Body 204 has a section 209 for the device to be held by a hand.

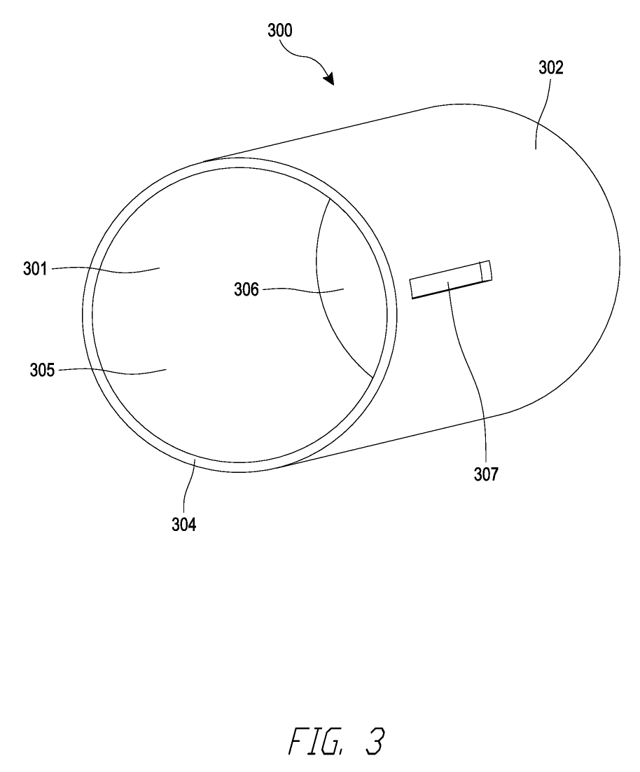

FIG. 3 illustrates a micro bubble device 300 of FIG. 2, with the distal cap sections removed to show the interior 301 of the device. The device comprises a generally cylindrical body 302 formed by walls 304 forming an interior outlet chamber 305. The remainder of the chamber is formed by an internal cross wall 306. Centered in cross wall 306, is a restriction passage (not shown), which is in fluid communication and with an outlet port 307. Outlet port 307 is an elongate slit cut through the wall 304 of cylindrical body 302.

Typically, the devices herein are formed with a single outlet port, such as 307.

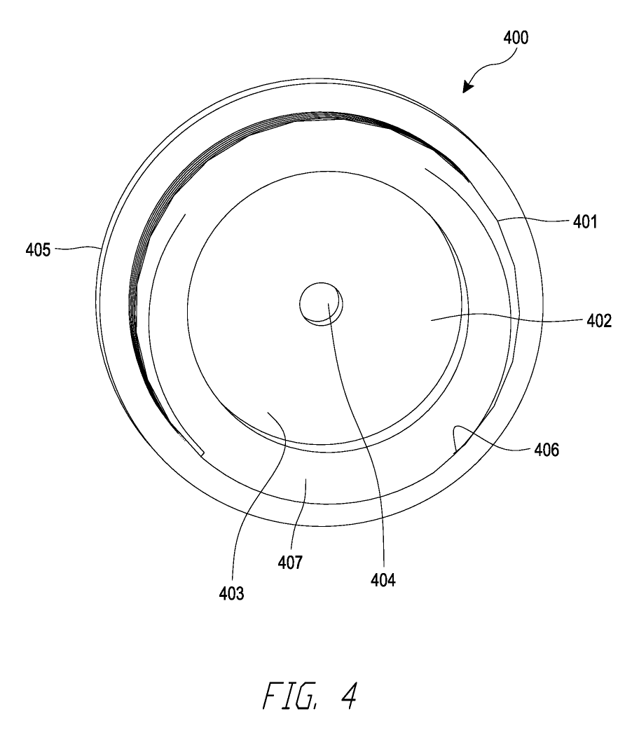

FIG. 4 illustrates a micro bubble device 400 having an inlet section 401 and a micro bubble generating section 402 comprising an internal cross wall 403 have a central, relatively small hole 404. In use, hole 404 has a venturi effect in the form of causing a reduction in fluid pressure, which causes air to be released from the water in the form of microbubbles. Micro bubble generator 403 forms an internal seal between the walls 405 of device 400 and forms an internal chamber (not shown) that communicates with an outlet (not shown).

In use, a supply of water having air dissolved therein or saturated with air is supplied to inlet 406. The water enters an inlet chamber section 407 and circulates therein before leaving the chamber by means of hole 404. Micro bubbles are caused to be generated from the water by micro bubble generator 403 and 404.

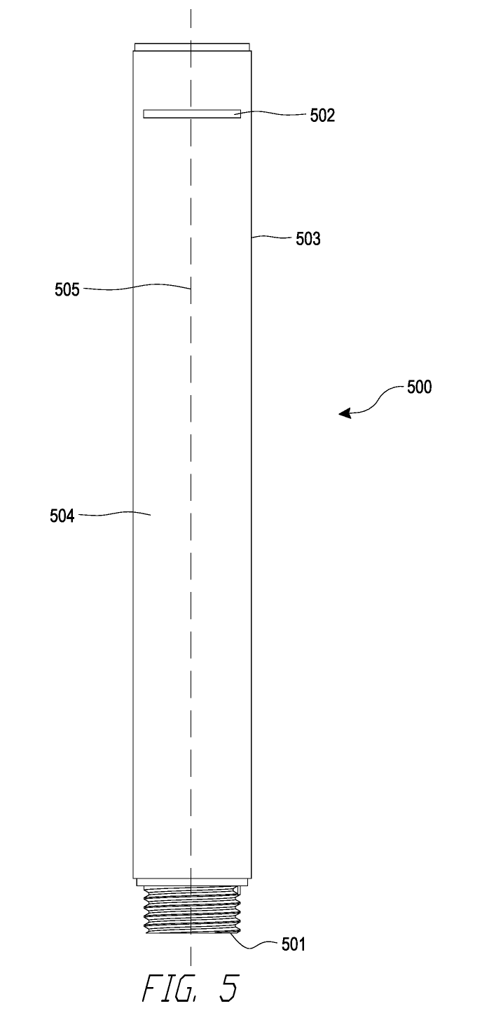

FIG. 5 illustrates a Microbubble device 500 having an inlet 501 communicating with a micro bubble generator (not shown) which in turn communicates with an outlet 502. Device 500 comprises substantially cylindrical walls 503 having a section 504 forming a hand held section. Outlet port 502 is formed in wall 503 and extends partially around the circumference and perpendicular to a central longitudinal axis 505.

What is claimed is:

1. A nozzle comprising:
an elongate, tubular body having a central, longitudinal axis;
the body comprising side walls;
an internal wall between said side walls;
the side walls and said internal wall forming a first internal chamber;
the first chamber having an inlet for conducting a liquid into the first chamber;
the body further comprising an external end wall, transverse to said axis, the side walls and said end wall forming a second internal chamber;
a passageway through said internal wall and in fluid communication between the first and the second chambers, the passageway sized to act as a liquid flow constriction, such that, in use, water saturated with air is caused to form micro bubbles;
an outlet from the second chamber formed in a side wall of the body for conducting out of the body, in use, a water and micro bubble mixture;
the outlet in the side wall being an elongate slit arranged in a plane either generally parallel or generally perpendicular to said axis;
the side walls between the inlet and the outlet being of a sufficient dimension to be gripped by the human hand.

2. A nozzle as claimed in claim 1, wherein said passageway is located on the longitudinal axis.

3. A nozzle as claimed in claim 2, wherein said passageway is a circular hole.

4. A nozzle as claimed in claim 1, wherein the body is generally cylindrical.

5. A nozzle as claimed in claim 1, wherein the slit comprises two substantially parallel long walls and two substantially parallel short walls so that the slit is substantially rectangular.

6. A nozzle as claimed in claim 5, wherein the ratio of a long wall to a short wall of is from about 30:1 to about 50:1.

7. A nozzle as claimed in claim 1, wherein the ratio between the cross sectional area of the outlet and the cross sectional area of the passageway is from about 20:1 to about 30:1.

8. A micro bubble generating shower wand comprising:
an elongate, hollow body comprising a central, longitudinal axis;
the body comprising side walls generally parallel to said axis; an inlet configured to conduct water into said hollow body, and a single outlet configured to direct water through a side wall and out of said hollow body in a direction generally perpendicular to said axis;
a micro bubble generating flow restricting passageway inside said body;
the body being configured without any additional water flow constriction passageway between said micro bubble generating flow restricting passageway and exit from the body by means of said outlet in said side wall.

9. A nozzle as claimed in claim 8, wherein the outlet in the side wall comprises an elongate slit arranged in a plane either generally parallel or generally perpendicular to said axis.

10. A nozzle as claimed in claim 8, wherein the micro bubble generating flow restricting passageway is located on said axis.

11. A nozzle as claimed in claim 8, wherein the wherein said passageway is a circular hole.

12. A nozzle as claimed in claim 8, wherein the outlet comprises two substantially parallel long walls and two substantially parallel short walls so that the slit is substantially rectangular.

13. A nozzle as claimed in claim 12, wherein the ratio of the length of a long wall to the length of a short wall is from about 30:1 to about 50:1.

14. A nozzle as claimed in claim 8, wherein the ratio between the cross sectional area of the outlet and the cross sectional area of the passageway is from about 20:1 to about 30:1.

15. A shower wand comprising:
an elongate, hollow body comprising a central, longitudinal axis;
the body being formed by walls forming a handgrip portion and an outlet portion comprising an outlet offset from the longitudinal axis;
a proximal end and a distal end;
an inlet for water adjacent the proximal end;
the outlet being located adjacent the distal end;
a constriction to flow of water through the body, located between the inlet and the outlet;
the constriction being configured to generate micro bubbles in water passing through the body;
the outlet being in the form of an elongated slit configured to project micro bubble containing water away from said axis for showering or bathing.

16. A nozzle as claimed in claim 15, wherein the outlet comprises a longer length and a shorter width and the ratio of the length to the width is from about 30:1 to about 50:1.

17. A nozzle as claimed in claim 15, wherein the ratio between the cross sectional area of the outlet and the cross sectional area of the constriction is from about 20:1 to about 30:1.

18. A bath or shower incorporating a nozzle according to claim 1.

19. A bath or shower incorporating a wand according to claim 7.

20. A bath or shower incorporating a wand according to claim 15.
